(19) United States
(12) Patent Application Publication
(10) Pub. No.: US 2011/0198994 A1
(43) Pub. Date: Aug. 18, 2011

(54) DISCHARGE LAMP COMPRISING A MONOXIDE RADIATION EMITTING MATERIAL

(75) Inventors: Rainer Hilbig, Aachen (DE); Achim Gerhard Rolf Koerber, Kerkrade (NL); Stefan Schwan, Herzogenrath (DE); Maria Huppertz, Hauset (BE)

(73) Assignee: KONINKLIJKE PHILIPS ELECTRONICS N.V., EINDHOVEN (NL)

(21) Appl. No.: 13/124,170

(22) PCT Filed: Oct. 8, 2009
(86) PCT No.: PCT/IB2009/054402

§ 371 Date: Apr. 14, 2011

(30) Foreign Application Priority Data
Oct. 15, 2008 (EP) 08166649.7

(51) Int. Cl. H01J 61/12

(52) U.S. Cl. 313/637

(57) ABSTRACT

The invention relates to a discharge lamp comprising a group IIIB or rare earth monoxide radiation emitting material, which allows to greatly improve the features of the lamp due to superior light emitting properties of the monoxide compound.

### FIELD OF THE INVENTION

The present invention is directed to novel materials for light emitting devices, especially to the field of novel materials for discharge lamps.

### BACKGROUND OF THE INVENTION

Discharge lamps are among the most prominent, widely used and popular forms of lighting. However, quite a lot of discharge lamps have the drawback that their emission spectrum suffers from a deficiency of green and red contributions, i.e. that the blue (and UV)—content is too prominent. This limits the attainable luminous efficacy of such a discharge vessel.

### SUMMARY OF THE INVENTION

It is an object of the present invention to provide an illumination system which is able to at least partly overcome the above-mentioned drawbacks and especially allows building a discharge lamp with improved lighting features for a wide range of applications.

This object is achieved by an illumination system according to claim 1 of the present invention. Accordingly, an illumination system, especially a discharge lamp, is provided comprising a gaseous monoxide radiation emitting material XO, wherein X is selected from the group IIIB (=Sc, La, Y), rare earth metals or mixtures thereof.

It has been found that for a wide range of applications within the present invention, such an illumination system has at least one of the following advantages:
The use of such an illumination system enables the light-technical properties to be greatly improved in an easy and effective way for a wide range of applications within the present invention;
The luminous efficacy is enhanced compared to a pure group IIIB metal-halide or rare earth halide discharge;
The color co-ordinates x, y are shifted towards the Planck locus (i.e. the discharge becomes “whiter”);
The color rendering properties are improved;
The materials used are non-toxic and are therefore usable for a wide range of applications within the present invention.

According to a preferred embodiment of the present invention, the light generating discharge is operated within a closed lamp vessel.

According to a preferred embodiment of the present invention, the monoxide radiation emitting material XO may then be continuously formed and destroyed in a regenerative chemical cycle, so that the light-technical properties of the operating system stay constant on a time scale in excess of one hour.

According to a preferred embodiment of the present invention, the monoxide radiation emitting material is formed in the gas of the operating discharge lamp from at least one, preferably two, precursors.

This has been advantageously shown for many applications within the present invention, since due to this feature, the properties of the illumination system, especially the lifetime of a system being a discharge lamp, may be greatly improved.

According to a preferred embodiment of the present invention, the monoxide radiation emitting material XO is generated by a reaction of at least one first metal compound, the metal being selected from the group comprising IIIB (=Sc, La, Y), rare earth metals or mixtures thereof, and at least one second transition metal compound.

The invention furthermore relates to an illumination system, especially a discharge lamp, comprising
at least one first metal compound, wherein the metal is selected from the group comprising IIIB (=Sc, La, Y), rare earth metals or mixtures thereof, and
at least one second oxygen-containing and/or donating compound.

The term “second oxygen-containing compound” especially means and/or includes that this compound (in the context of this application for better readability simply called “second compound”) comprises oxygen and at least one further non-metal element besides oxygen.

The term “second oxygen-donating compound” especially means and/or includes that this compound will react with other substances present in the lamp (i.e. oxygen-containing impurities) to form an oxygen-containing compound.

It has been found that, for a wide range of applications within the present invention, such an illumination system has at least one of the following advantages:
The use of such an illumination system enables the light-technical properties to be greatly improved in an easy and effective way for a wide range of applications within the present invention:
The luminous efficacy is enhanced compared to a pure group IIIB metal-halide or rare earth halide discharge;
The color co-ordinates x, y are shifted towards the Planck locus (i.e. the discharge becomes “whiter”);
The color rendering properties are improved;
The materials used are non-toxic and are therefore usable for a wide range of applications within the present invention.

Without being bound to any theory, the inventors believe that by using such a first and second compound, it is possible for a wide range of applications that especially the monoxide radiation emitting material is generated to such an extent that it influences the lighting properties of the illumination system.

This is believed to be ascribable to diffusion of the compounds in the hot central region of the discharge, where they are dissociated into the atoms. Then the atoms recombine into the desired monoxides which finally emit the desired molecular radiation.

Surprisingly, it has been found that, for a wide range of applications within the present invention, the second compound does not need to be an oxide halide compound. The source of oxygen in these embodiments is believed to come from oxygen containing impurities introduced during the manufacturing process or from reactions of the transition metal halide filling with the discharge vessel material (like e.g. SiO₂). In these embodiments it is believed that the second compound first reacts with these impurities and/or the SiO₂ to form an intermediate oxide halide compound which then further reacts. Therefore such second compounds are considered to be “oxygen-donating materials” in the sense of the present invention.

Preferably at least one of these first and/or second compounds has a vapor pressure of ≧0.01 Pa at 900 K.

If the vapor pressure of one compound is not known at 900 K, it may be estimated by well-known thermodynamic methods, for example by using the Clausius-Clapeyron equation to extrapolate the vapor pressure curve for temperatures beyond the temperature range for which literature data are known.

According to a preferred embodiment of the present invention, at least one of these first and/or second compounds has a vapor pressure of ≧0.025 Pa, preferably ≧0.05 Pa and most preferably ≧0.10 Pa at 900 K.

According to a preferred embodiment of the present invention, the first compound is selected from the group comprising fluorides, chlorides, bromides, iodides or mixtures thereof.

According to a preferred embodiment of the present invention, the second compound comprises a transition metal compound. Transition metal compounds in the sense of the present invention especially include metal halides, metal oxides and/or metal oxide halides.

According to a preferred embodiment of the present invention, the second compound is selected from the group comprising group VB elements, group VB element halides, group VB element oxide halides, group VIB elements, group VIB element halides, group VIB element oxide halides, or mixtures thereof.

According to a preferred embodiment of the present invention, the at least one second compound comprises a metal, a metal halide, a metal oxide and/or a metal oxide halide compound, the metal being selected from the group comprising V, Nb, Ta, Cr, Mo, W or mixtures thereof.

According to a further preferred embodiment of the present invention, the second compound comprises at least one element selected from the group comprising B, C, P, As, Sb, Ge, S, Se, Te, F, Cl, Br, I, preferably in a high oxidation state

The term “high oxidation state” especially means the highest and/or second highest oxidation state that is usually found in chemical compounds comprising this element. In the context of this embodiment, especially the following oxidation states for the following elements are preferred:

TABLE I

| | Preferred oxidation |
|---|---|
| Element | state(s) |
| C | +4, +3 |
| P | +5, +4 |
| As | +5, +3 |
| Sb | +5, +3 |
| Ge | +4 |
| S | +6, +4 |
| Se | +6, +4 |
| Te | +4 |
| Cl | +7, +5 |
| Br | +5 |
| I | +7, +5 |

According to a preferred embodiment of the present invention, the second compound is selected from the group comprising P₄O₁₀, SeO₂, TeO₂, formates, perchlorates, chlorates, bromates, periodates, iodates or mixtures thereof.

According to a preferred embodiment of the present invention, the ratio of the first compound to the second compound (in mol:mol) is ≧0.01:1 and ≦1000:1, preferably ≧0.1:1 and ≦100:1 and most preferably ≧0.5:1 and ≦20:1

According to a preferred embodiment of the present invention, the illumination system comprises a discharge vessel, which is preferably made of amorphous or (poly)crystalline oxides or mixtures thereof, especially those used in the technology of discharge lamps. Preferably, the vessel material is SiO₂ (quartz) or Al₂O₃ (polycrystalline alumina or sapphire). Alternatively, other vessel materials such as e.g. soft glass could be used, if protected by a suitable (oxide) coating against attack from the lamp filling.

According to a preferred embodiment of the present invention, the content of the first compound and/or the second compound inside the gas vessel is ≧10⁻¹² mol/cm³ and ≦10⁻⁴ mol/cm³, preferably ≧10⁻¹¹ mol/cm³ and ≦10⁻⁵ mol/cm³.

According to a preferred embodiment of the present invention, the discharge lamp is a HID lamp, a dielectric barrier discharge (DBD) lamp, a TL, CFL and/or QL low-pressure discharge lamp operated either electrodeless (capacitively or inductively) in the RF or microwave frequency range and/or with internal electrodes (in the latter case it is especially preferred that the electrode material comprises tungsten) at low frequencies or DC.

In case the illumination system comprises or is an HID or DBD lamp, it is especially preferred that the content of the first compound and/or the second compound inside the gas vessel is ≧10⁻⁸ mol/cm³ and ≦10⁻⁴ mol/cm³, preferably ≧10⁻⁷ mol/cm³ and ≦10⁻⁵ mol/cm³.

In case the illumination system comprises or is a TL, CFL and/or QL low-pressure discharge lamp, it is especially preferred that the content of the first compound and/or the second compound inside the gas vessel is ≧10⁻¹¹ mol/cm³ and ≦10⁻⁶ mol/cm³, preferably ≧10⁻¹⁰ mol/cm³ and ≦10⁻⁷ mol/cm³.

According to a preferred embodiment of the present invention, the illumination system comprises a gas filling, wherein the gas filling comprises an inert buffer gas. The buffer gas may be a noble gas, nitrogen or mercury. More preferably, the buffer gas is selected from the group formed by helium, neon, argon, krypton and xenon or mixtures thereof.

According to a preferred embodiment of the present invention, the illumination system comprises at least one third low-stability oxygen-containing compound (hereinafter referred to as “third compound”).

The term “third low-stability oxygen-containing compound” especially means and/or includes that this compound (in the context of this application for better readability simply referred to as “third compound”) either decomposes upon heating above 100° C. and/or has a negative enthalpy of formation of ≦100 kJ/mol, according to one embodiment ≦70 kJ/mol, per oxygen atom present in the third compound.

According to a preferred embodiment of the present invention, the third compound comprises and/or is a noble metal oxide or oxy-halide.

These compounds have been found to be of great use within the present invention due to their usually high decomposition tendency at elevated temperatures.

Preferably, the third compound is selected from the group comprising Au₂O₃, Pt₃O₄, Rh₂O, RuO₄, Ag₂O, Ag₂O₂ and Ag₂O₃ or mixtures thereof.

Some properties of some “third compounds” according to the present invention are shown in the—merely illustrative and non-binding—table II:

TABLE II

| | | Negative Enthalpy |
|---|---|---|
| | Enthalpy | of formation |
| | of formation | per oxygen atom |
| Compound | [kJ/mol] | [kJ/mol] |
| Au₂O₃ | −3.43 | 1.14 |
| Pt₃O₄ | −166.22 | 41.56 |
| Ag₂O | −30.54 | 30.54 |
| Ag₂O₂ | −24.27 | 12.13 |
| Ag₂O₃ | 33.89 | −11.30 |
| RuO₄ | −239.32 | 59.83 |
| Rh₂O | −94.98 | 94.98 |

An illumination system according to the present invention may be of use in a broad variety of systems and/or applications, amongst them one or more of the following:
Office lighting systems
household application systems
shop lighting systems,
home lighting systems,
accent lighting systems,
spot lighting systems,
theater lighting systems,
fiber-optics application systems,
projection systems,
self-lit display systems,
pixelated display systems,
segmented display systems,
warning sign systems,
medical lighting application systems,
decorative lighting systems
portable systems
automotive applications
greenhouse lighting systems

The aforementioned components, as well as the claimed components and the components to be used in accordance with the invention in the described embodiments, are not subject to any special exceptions with respect to their size, shape, material selection and technical concept, so that the selection criteria known in the pertinent field can be applied without limitations.

### BRIEF DESCRIPTION OF THE DRAWINGS

Additional details, features, characteristics and advantages of the object of the invention are disclosed in the subclaims, the Figures and the following description of the respective Figures and examples, which—in an exemplary fashion—show several embodiments and examples of illumination systems according to the present invention.

FIG. 1 shows a measured and simulated emission spectrum of a discharge lamp according to Example I of the present invention.

FIG. 2 shows a measured and simulated emission spectrum of a discharge lamp according to Example II of the present invention.

FIG. 3 shows a measured and simulated emission spectrum of a discharge lamp according to Example III of the present invention.

FIG. 4 shows a measured emission spectrum of a discharge lamp according to Example IV of the present invention.

FIG. 5 shows a measured emission spectrum of a discharge lamp according to Example V of the present invention.

FIG. 6 shows a measured emission spectrum of a discharge lamp according to Example VI of the present invention.

FIG. 7 shows a measured emission spectrum of a discharge lamp according to Example VII of the present invention.

FIG. 8 shows a measured emission spectrum of a discharge lamp according to Example VIII of the present invention.

FIG. 9 shows a measured emission spectrum of a discharge lamp according to Example IX of the present invention.

### EXAMPLE I

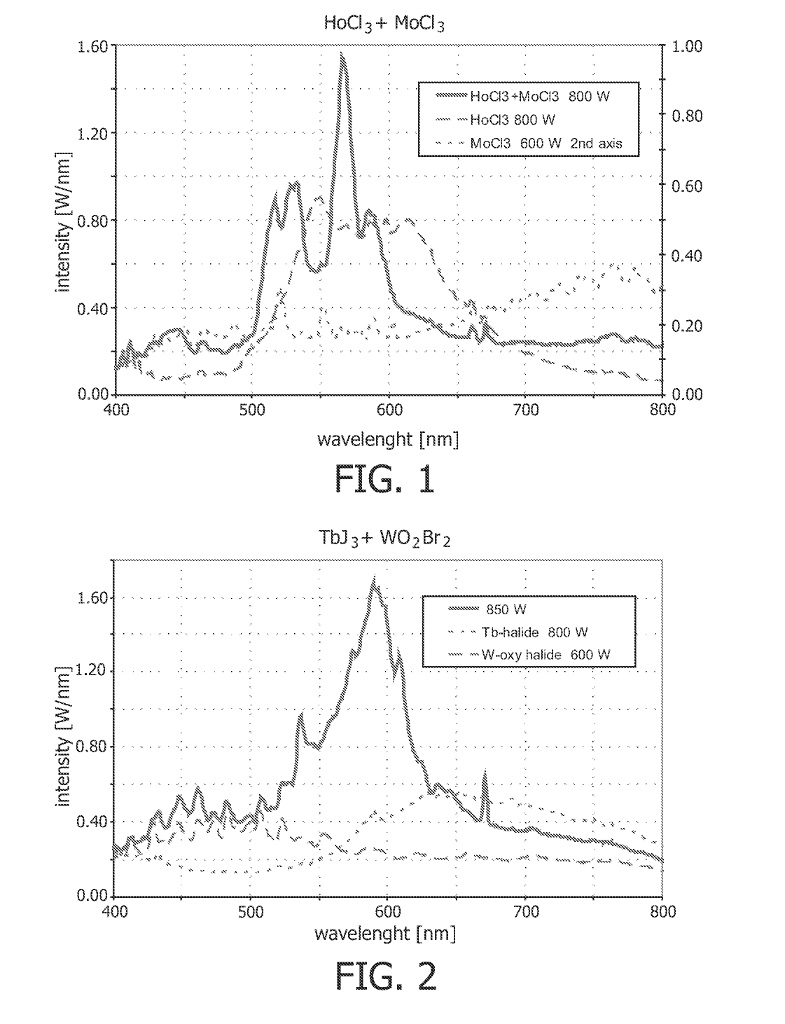

FIG. 1 refers to Example I which was set up as follows:

A spherical quartz vessel of 32.5 mm inner diameter, i.e. a volume of 18 ccm, was filled with 0.57 mg HoCl₃, 0.39 mg MoCl₃ and 100 mbar (=fill pressure at room temperature) Ar. This lamp (referred to as HoMoH1) was operated in a 2.45 GHz microwave resonator at 800 W and emitted the spectrum shown in FIG. 1 for the wavelength range of 400 nm-800 nm. Also given are the spectral emission properties of such lamps filled at the same buffer gas pressure but only with 0.48 mg MoCl₃ (lamp MoCH1, dashed line in FIG. 1) or only with 0.58 mg HoCl₃ (lamp HoClH1, dotted line).

The emission spectrum of lamp HoMoH1 strongly differs from that of the pure fillings. It is not a combination of the 2 spectra but it shows totally different emission behaviour. The spectrum is shifted to the green/blue and is much narrower than the spectra of lamps MoCH1 and HoClH1. Main emission takes place between 500 nm and 600 nm!

This significant change in spectral properties is assumed to be due to the formation of stable (diatomic) holmium-monoxide HoO molecules within the radiating plasma zone.

### EXAMPLE II

FIG. 2 refers to Example II which was set up as follows:

A spherical quartz vessel of 32.5 mm inner diameter, i.e. a volume of 18 ccm, was filled with 1.8 mg TbJ₃, 1.0 mg WO₂Br₂ and 100 mbar (=fill pressure at room temperature) Ar. This lamp (referred to as TbWH1) was operated in a 2.45 GHz microwave resonator at 850 W and emitted the spectrum shown in FIG. 2. Also given are the spectral emission properties of a pure terbium halide lamp (dotted line in FIG. 2) or a pure tungsten oxy-halide discharge (dashed line).

As discussed in Example I, the emitted radiation of the mixture significantly differs from that of the pure fillings or from that of a combination of the pure spectra due to the assumed formation of TbO. Intense radiation in the green, yellow and near red spectral range is generated.

### EXAMPLE III

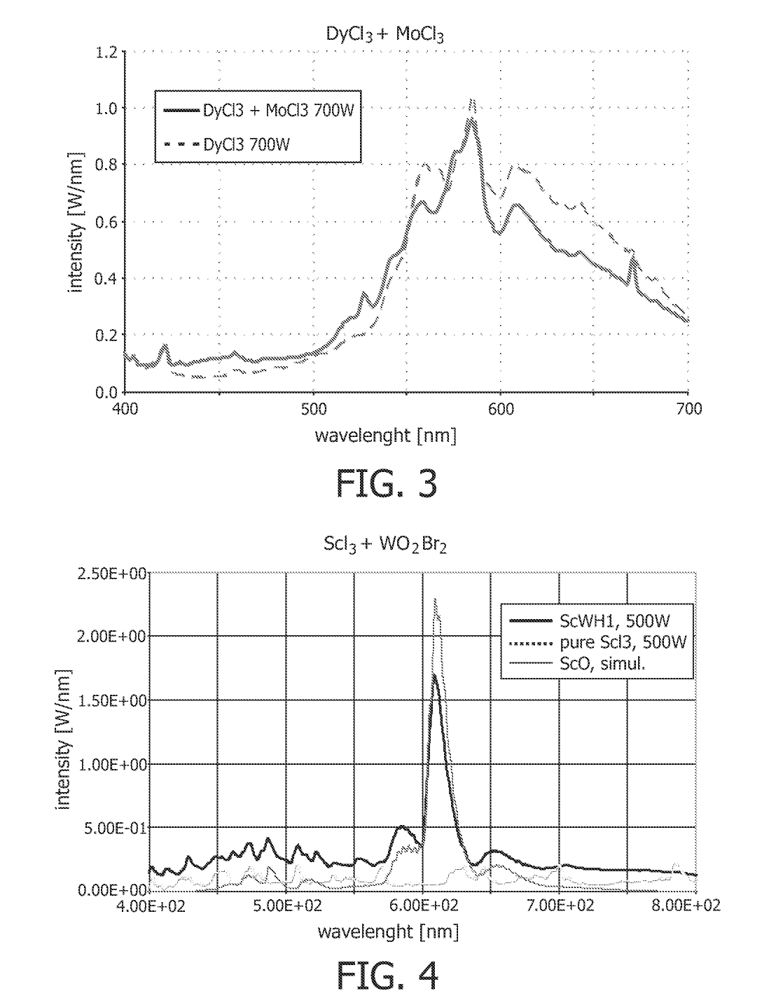

FIG. 3 refers to Example III which was set up as follows:

A spherical quartz vessel of 32.5 mm inner diameter, i.e. a volume of 18 ccm, was filled with 0.56 mg DyCl₃, 0.3 mg MoCl₃ and 100 mbar (=fill pressure at room temperature) Ar. This lamp (referred to as DyMoH1) was operated in a 2.45 GHz microwave resonator at 700 W and emitted the spectrum shown in FIG. 3 (solid line). Also given is the spectral emission property of a pure dysprosium halide lamp (dashed line in FIG. 3).

The emission spectrum of lamp DyMoH1 differs from that of the pure filling. The spectrum is slightly shifted to the green/blue and emits less in the wavelength range of 600 nm-700 nm. The spectral width is narrowed relative to the pure filling.

The change in spectral properties is assumed to be due to the formation of stable (diatomic) DyO within the radiating plasma zone.

### EXAMPLE IV

FIG. 4 refers to Example IV which was set up as follows:

A spherical quartz vessel of 32.5 mm inner diameter, i.e. a volume of 18 ccm, was filled with 1.3 mg ScI₃, 0.97 mg WO₂Br₃ and 100 mbar (=fill pressure at room temperature) Ar. This lamp (referred to as ScWH1) was operated in a 2.45 GHz microwave resonator at 500 W and emitted the spectrum shown in FIG. 4 (solid line). Also given is the spectral emission property of a pure scandium iodide lamp (dashed line in FIG. 4).

The emission spectrum of lamp ScWH1 differs from that of the pure filling. The spectrum strongly peaks in the red around λ=610 nm! The spectral width of this peak is only about 20 nm.

The change in spectral properties is assumed to be due to the formation of stable (diatomic) ScO within the radiating plasma zone.

### EXAMPLE V

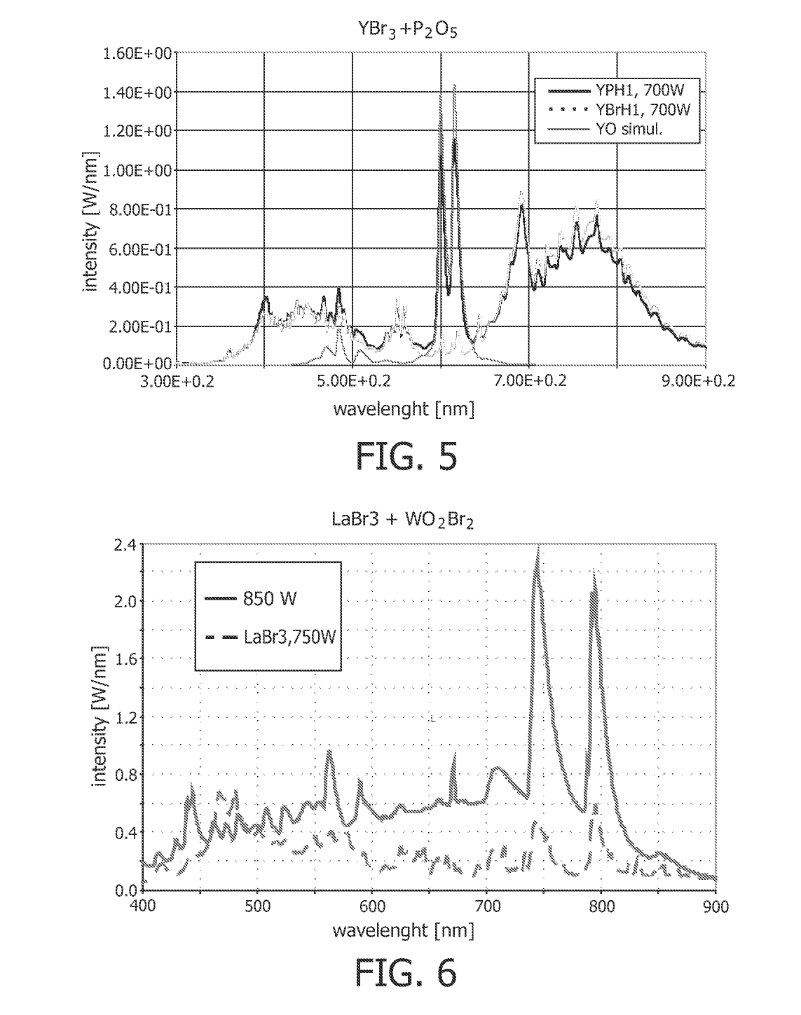

FIG. 5 refers to Example V which was set up as follows:

A spherical quartz vessel of 32.5 mm inner diameter, i.e. a volume of 18 ccm, was filled with 1.39 mg YBr₃, 0.21 mg P₂O₅ and 100 mbar (=fill pressure at room temperature) Ar. This lamp (referred to as YPH1) was operated in a 2.45 GHz microwave resonator at 700 W and emitted the spectrum shown in FIG. 5 (thick solid line). Also given is the simulated spectral emission property of two YO band systems (thin line in FIG. 5) and the spectrum emitted by lamp YBrH1, dosed with 0.70 mg YBr₃, but without P₂O₅ (dotted black line in FIG. 5).

The change in spectral properties is assumed to be due to the formation of stable (diatomic) YO within the radiating plasma zone.

### EXAMPLE VI

FIG. 6 refers to Example VI which was set up as follows:

A spherical quartz vessel of 32.5 mm inner diameter, i.e. a volume of 18 ccm, was filled with 0.78 mg LaBr₃, 1.06 mg WO₂Br₃ and 100 mbar (=fill pressure at room temperature) Ar. This lamp (referred to as LaWH1) was operated in a 2.45 GHz microwave resonator at 850 W and emitted the spectrum shown in FIG. 6 (solid line). Also given is the spectral emission property of a pure lanthanum bromide lamp operated at a power of 750 W (dashed line in FIG. 6).

The emission spectrum of lamp LaWH1 differs from that of the pure filling. First of all, the emission is much more intense. The spectrum strongly peaks in the red around λ=750 nm and 800 nm. The spectral width of these peaks is only about 20 nm.

The change in spectral properties is assumed to be due to the formation of stable (diatomic) LaO within the radiating plasma zone.

### EXAMPLE VII

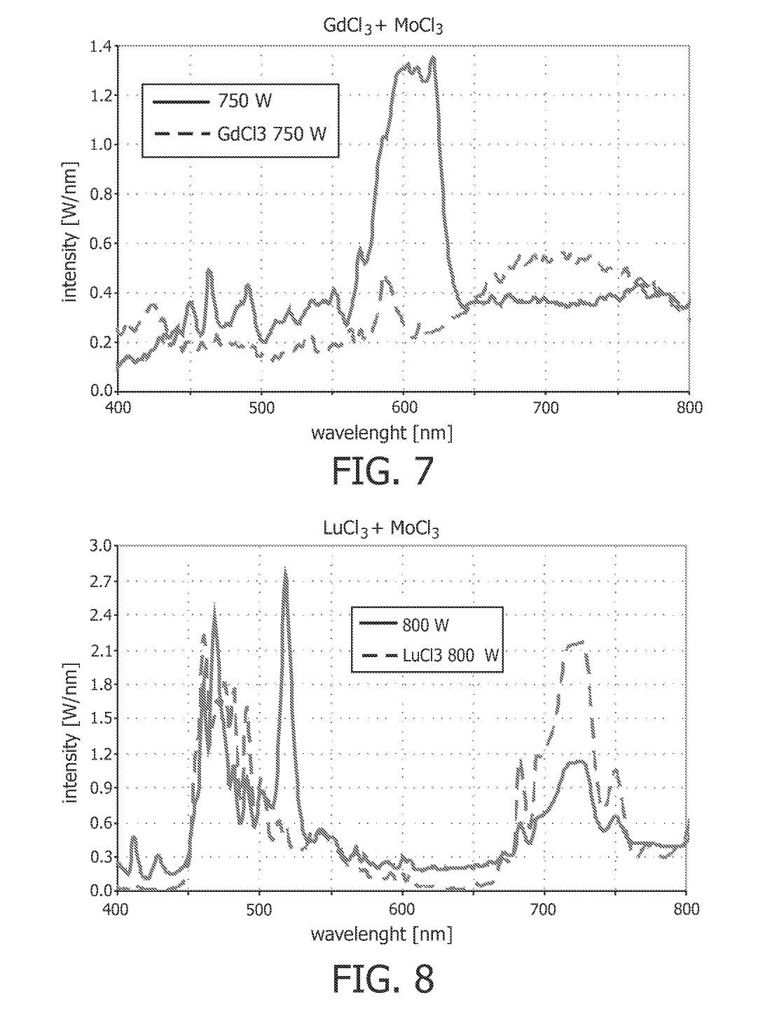

FIG. 7 refers to Example VII which was set up as follows:

A spherical quartz vessel of 32.5 mm inner diameter, i.e. a volume of 18 ccm, was filled with 0.65 mg GdCl₃, 0.42 mg MoCl₃ and 100 mbar (=fill pressure at room temperature) Ar. This lamp (referred to as GdMoH1) was operated in a 2.45 GHz microwave resonator at 750 W and emitted the spectrum shown in FIG. 7 (solid line). Also given is the spectral emission property of a pure gadolinium chloride lamp operated also at a power of 750 W (dashed line in FIG. 7).

The emission spectrum of lamp GdMoH1 differs from that of the pure filling. First of all, the emission is much more intense in the yellow/red spectral region (λ=570 nm-630 nm). There is also some extra light emitted between λ=450 nm and 500 nm.

The change in spectral properties is assumed to be due to the formation of stable (diatomic) GdO within the radiating plasma zone.

### EXAMPLE VIII

FIG. 8 refers to Example VIII which was set up as follows:

A spherical quartz vessel of 32.5 mm inner diameter, i.e. a volume of 18 ccm, was filled with 0.54 mg LuCl₃, 0.39 mg MoCl₃ and 100 mbar (=fill pressure at room temperature) Ar. This lamp (referred to as LuMoH1) was operated in a 2.45 GHz microwave resonator at 800 W and emitted the spectrum shown in FIG. 8 (solid line). Also given is the spectral emission property of a pure lutetium chloride lamp operated also at a power of 800 W (dashed line in FIG. 8).

The pure filling (LuCl₃, red dotted curve) already exhibits intense radiation in the blue spectral range (λ=450 nm-500 nm) as well as in the infrared range (λ=670 nm-750 nm). The emission spectrum of lamp LuMoH1 significantly differs from that of the pure filling; the emission in the blue range is more peaked, there is an additional narrow emission at λ=520 nm; the IR-emission is diminished.

The change in spectral properties is assumed to be due to the formation of stable (diatomic) GdO within the radiating plasma zone

### EXAMPLE IX

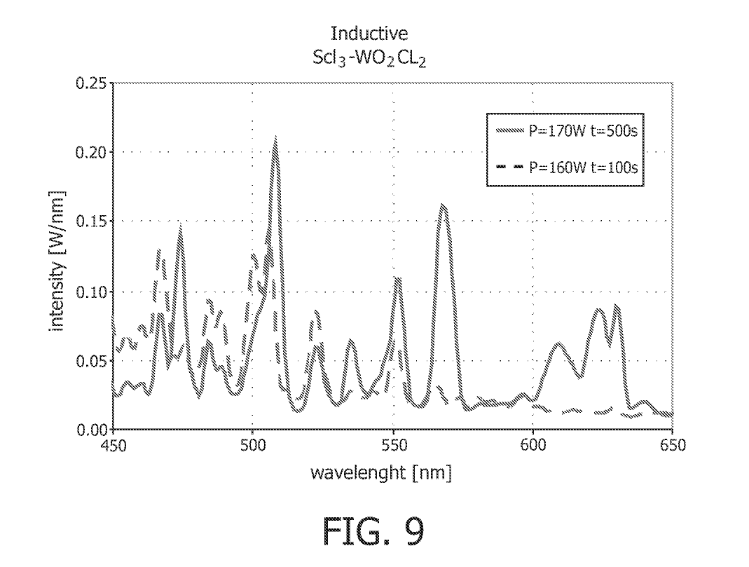

FIG. 9 refers to Example IX which was set up as follows:

A tubular quartz tube with 23 mm inner diameter and 37 mm length, i.e. a volume of 15 ccm, was filled with 0.75 mg ScI₄, 0.33 mg WO₂Cl₂ and 40 mbar Xe (pressure at room temperature). About 165 W of RF power of 14 MHz frequency were inductively coupled into the lamp by means of an external air coil on the burner (two 1 mm silver wires in parallel, 6 windings). This burner is operated in an overcladding filled with air (hard glass tube, 50 mm outer diameter, 50 mm length). The emission spectrum of FIG. 9 (solid line) has been measured after running the lamp at P=170 W for 500 s. Also given is the spectral emission property of the same lamp operated at P=160 W for only t=100 s (i.e. lower coldest spot temperature; dashed line in FIG. 9).

Operating the lamp at a higher coldest spot temperature (i.e. t=500 s, solid line in FIG. 9) changes the emission spectrum significantly compared to the emission spectrum when the lamp is operated for only 100 s (red dotted curve). The blue emission spectrum is changed, there are additional emission lines at λ=530 nm, 570 nm and between 600 nm and 630 nm.

The change in spectral properties is assumed to be due to the formation of stable (diatomic) ScO within the radiating plasma zone

The particular combinations of elements and features in the above detailed embodiments are exemplary only; the interchanging and substitution of these teachings with other teachings in this application and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

1. Illumination system, especially a discharge lamp, comprising a monoxide radiation emitting material XO, wherein X is selected from the group comprising IIIB (=Sc, La, Y), rare earth metals or mixtures thereof.

2. Illumination system according to claim 1, wherein the light generating discharge is operated within a closed lamp vessel.

3. Illumination system according to claim 1, wherein the monoxide radiation emitting material XO is generated by a reaction of at least one first metal compound, the metal being selected from the group comprising IIIB (=Sc, La, Y), rare earth metals or mixtures thereof, and at least one second transition metal compound.

4. Illumination system, especially a discharge lamp, comprising
at least one first metal compound, wherein the metal is selected from the group comprising IIIB (=Sc, La, Y), rare earth metals or mixtures thereof, and
at least one second oxygen-containing and/or donating compound.

5. Illumination system according to claim 4, wherein the content of the first compound and/or the second compound inside the gas vessel is ≧10⁻¹² mol/cm³ and ≦10⁻⁴ mol/cm³.

6. Illumination system according to claim 2, wherein the first compound is selected from the group comprising fluorides, chlorides, bromides, iodides or mixtures thereof.

7. Illumination system according to claim 4, wherein the second compound is selected from the group comprising group VB elements, group VB element halides, group VB element oxide halides, group VIB elements, group VIB element halides, group VIB element oxide halides, or mixtures thereof.

8. Illumination system according to claim 4, wherein the second compound comprises at least one element selected from the group comprising B, C, P, As, Sb, Ge, S, Se, Te, F, Cl, Br, I, preferably in a high oxidation state.

9. Illumination system according to claim 1, wherein the discharge lamp is a HID lamp, a dielectric barrier discharge (DBD) lamp, a TL, CFL and/or QL low-pressure discharge lamp operated either electrodeless (capacitively or inductively) in the RF or microwave frequency range and/or with internal electrodes at low frequencies or DC.

10. A system comprising an illumination system according to claim 1, the system being used in one or more of the following applications:
Office lighting systems
household application systems
shop lighting systems,
home lighting systems,
accent lighting systems,
spot lighting systems,
theater lighting systems,
fiber-optics application systems,
projection systems,
self-lit display systems,
pixelated display systems,
segmented display systems,
warning sign systems,
medical lighting application systems,
indicator sign systems, and
decorative lighting systems
portable systems
automotive applications
greenhouse lighting systems
